(19) United States
(12) Patent Application Publication
(10) Pub. No.: US 2026/0349123 A1
(43) Pub. Date: Nov. 5, 2026

(54) RADIATION DETECTOR

(71) Applicant: Sharp Display Technology Corporation, Kameyama City (JP)

(72) Inventor: Yu NAKAMURA, Kameyama City (JP)

(21) Appl. No.: 19/554,824

(22) Filed: Mar. 3, 2026

(30) Foreign Application Priority Data
Mar. 4, 2025 (JP) 2025-033610

(51) Int. Cl. G01T 1/202; G01T 1/20

(52) U.S. Cl. CPC G01T 1/2023; G01T 1/2018

(57) ABSTRACT

A radiation detector includes an active matrix substrate having placed thereon a plurality of pixels having their respective switching elements and their respective photoelectric conversion elements and a scintillator placed on top of the active matrix substrate so as to cover the photoelectric conversion elements. The scintillator is constituted by columnar crystals of cesium iodide activated by thallium. The scintillator has first and second layers stacked on top of each other between first and second surfaces. The columnar crystals grow from the first surface toward the second surface. The second layer is located closer to the second surface than is the first layer. The second layer is lower in thallium concentration than the first layer.

### BACKGROUND

### 1. Field

The present disclosure relates to a radiation detector.

### 2. Description of the Related Art

With the development of image processing technologies, various diagnostic imaging devices have been widely used also in the field of medicine. In a diagnostic device that uses radiation such as X-rays, a radiation flat panel detector (FPD) that is capable of directly converting, into digital data, radiation transmitted through a body or a physical object. For example, Japanese Unexamined Patent Application Publication No. 2017-078637 discloses a radiation detector that uses cesium iodide as a scintillator.

For more accurate diagnostic imaging, it is desirable that a radiation detector have a high resolution. It is desirable to provide a radiation detector that is capable of detecting radiation with a high resolution.

### SUMMARY

According to an aspect of the disclosure, there is provided a radiation detector including an active matrix substrate including a substrate and a plurality of pixels, placed on top of the substrate, that include their respective switching elements and their respective photoelectric conversion elements and a scintillator placed on top of the active matrix substrate so as to cover the photoelectric conversion elements of the plurality of pixels. The scintillator is constituted by columnar crystals of cesium iodide activated by thallium. The scintillator has first and second surfaces separated from each other in a thickness direction and first and second layers stacked on top of each other in the thickness direction between the first and second surfaces. The columnar crystals grow from the first surface toward the second surface. The second layer is located closer to the second surface than is the first layer. The second layer is lower in thallium concentration than the first layer.

### BRIEF DESCRIPTION OF THE DRAWINGS

FIG. 1 is an enlarged cross-sectional view showing a configuration of principal components of a radiation detector of a first embodiment;

FIG. 2 is a schematic circuit diagram showing an example configuration of the radiation detector;

FIG. 3 is an enlarged cross-sectional view showing a configuration of principal components of a radiation detector including a scintillator having only a first layer;

FIG. 4 is a schematic view explaining propagation of scintillation light based on X-rays incident on the radiation detector shown in FIG. 1;

FIG. 5 is a schematic view explaining propagation of scintillation light based on X-rays incident on the radiation detector shown in FIG. 3;

FIG. 6A is a diagram showing a surface structure of a scintillator in the radiation detector shown in FIG. 1;

FIG. 6B is a diagram showing a surface structure of a scintillator in the radiation detector shown in FIG. 3;

FIG. 7 shows contrast ratios at positions shown in FIGS. 6A and 6B of MTF curves of the radiation detectors shown in FIGS. 1 and 3;

FIG. 8 is an enlarged cross-sectional view showing a configuration of principal components of a radiation detector of a second embodiment; and

FIG. 9 is a schematic view explaining propagation of scintillation light based on X-rays incident on the radiation detector shown in FIG. 8.

### DESCRIPTION OF THE EMBODIMENTS

Embodiments of the present disclosure are described below with reference to the drawings. The present disclosure is not limited to the following embodiments but can be designed and changed as appropriate as far as a configuration of the present disclosure is fulfilled. Further, in the following description, identical components or components having similar functions are given identical reference signs in common throughout different drawings, and a repeated description of such components may be omitted. Further, configurations described in the embodiments and modifications may be combined or may be changed as appropriate without departing from the scope of the present disclosure. For ease of understanding of explanation, the drawings to be referred to below may show configurations in a simplistic form or in a schematic form or may omit some constituent members. Further, dimensional ratios between constituent members shown in the drawings do not necessarily represent actual dimensional ratios.

### First Embodiment

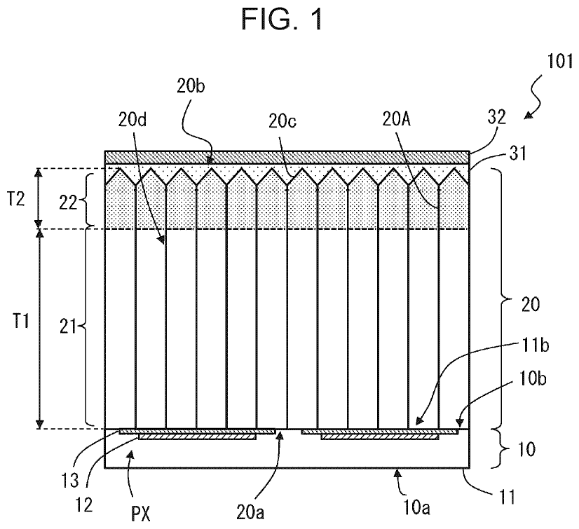

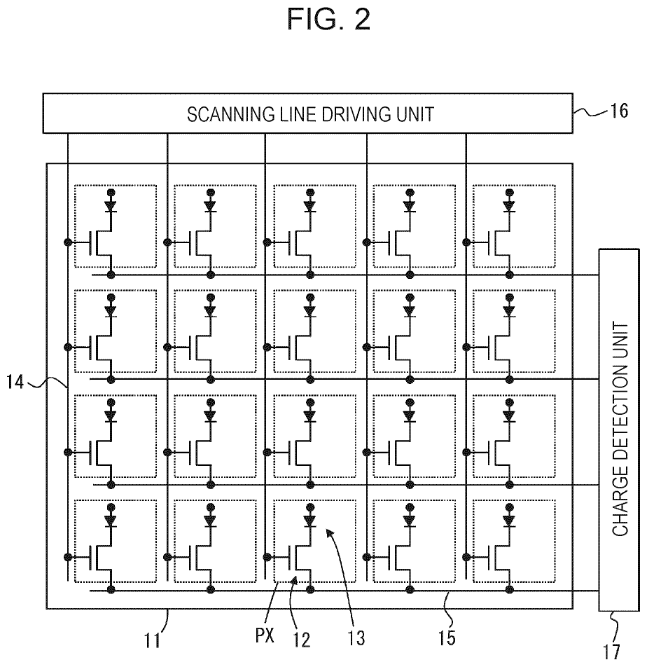

FIG. 1 is an enlarged cross-sectional view showing a configuration of principal components of a radiation detector 101 of the present embodiment, and FIG. 2 is a schematic circuit diagram showing an example circuit configuration of the radiation detector 101. The radiation detector 101 includes an active matrix substrate 10 and a scintillator 20.

The active matrix substrate 10 includes a substrate 11 and a plurality of pixels PX one-dimensionally or two-dimensionally arrayed beside an upper surface 11b of the substrate 11. In the present embodiment, the plurality of pixels PX are two-dimensionally arranged in rows and columns. Each pixel PX includes a switching element and a photoelectric conversion element electrically connected to the switching element. The switching element is an active element such as a MIM element or a TFT, and in the present embodiment, the pixel PX includes a TFT 12. The TFT 12 includes either an oxide semiconductor layer containing at least one type of element selected from the group consisting of In, Ga, and Zn or a Si semiconductor layer. The oxide semiconductor layer and the Si semiconductor layer may have various types of crystallinity such as polycrystallinity, microcrystallinity, and c-axis orientation.

The photoelectric conversion element receives scintillation light emitted from the after-mentioned scintillator and generates an electric charge by photoelectric conversion. The photoelectric conversion element is, for example, an element including a semiconductor layer and having various structures that can separate a hole-electron pair produced by a photon falling on the semiconductor layer. In the present embodiment, the pixel PX includes a photodiode 13. The photodiode 13 includes, for example, an i-type Si semiconductor layer, a p-type Si semiconductor layer, and an n-type Si semiconductor layer, and the i-type Si semiconductor layer is sandwiched between the p-type Si semiconductor layer and the n-type Si semiconductor layer. The pixel PX may further include an amplifier circuit that amplifies an electric charge generated in the photodiode 13.

The active matrix substrate 10 includes a plurality of scanning lines 14 and a plurality of data lines 15, and for example, gates of the TFTs 12 of a plurality of pixels PX arranged in a column are connected to one scanning line 14. Further, sources of the TFTs 12 of a plurality of pixels PX arranged in a row are connected to one data line 15.

In the active matrix substrate 10, various insulating layers and interlayer insulating films are placed between constituent elements that need electrically separating, such as the TFTs 12, the photodiodes 13, the scanning lines 14, and the data lines 15. On an upper surface 10b of the active matrix substrate 10, the photodiodes 13 are located.

The radiation detector 101 further includes a scanning line driving unit 16 and a charge detection unit 17. The scanning line driving unit 16 selects the plurality of scanning lines 14 in sequence and applies a predetermined voltage to the scanning line 14 thus selected. This turns on the TFTs 12 of pixels PX connected to the scanning line 14 thus selected and causes electric charges accumulated in the photodiodes 13 to be read out to the charge detection unit 17 via the data lines 15. The charge detection unit 17 detects the electric charges thus received and converts the electric charges into electrical signals.

The scintillator 20 is constituted by a material suited to radiation used. The radiation may be X-rays, α-rays, γ-rays, or other beams of radiation, and in a radiation FPD for use in medicine or industry, X-rays are widely used. In the present embodiment, the radiation detector 101 detects X-rays, and the scintillator 20 is constituted by cesium iodide activated by thallium. Cesium iodide activated by thallium is represented by CSI:Tl or CsI(Tl). More specifically, the scintillator 20 is constituted by polycrystals of cesium iodide each having a columnar crystal structure, and each columnar crystal 20A extends in a thickness direction of the scintillator 20 and has a thickness less than or equal to approximately several micrometers to 10μm. Side faces of adjacent columnar crystals may be in contact with or separate from each other.

The scintillator 20 has first and second surfaces 20a and 20b separated from each other in a thickness direction and first and second layers 21 and 22 stacked on top of each other in the thickness direction between the first and second surfaces 20a and 20b. The first surface 20a faces the upper surface 10b of the active matrix substrate 10.

The first layer 21 is located closer to the first surface 20a than is the second layer 22, and the second layer 22 is located closer to the second surface 20b than is that first layer 21. The first layer 21 and the second layer 22 are different in concentration of elemental thallium from each other.

Specifically, the second layer 22 is lower in thallium concentration than the first layer 21. A concentration of thallium in the second layer 22 is lower than or equal to 1/10, preferably lower than or equal to 1/5, of a concentration of thallium in the first layer 21. Note here that the thallium concentrations in the first and second layers 21 and 22 are represented by mass% of CsI with respect to Cs. For example, the thallium concentration in the first layer 21 is approximately 0.01 mass % to several mass percent. More preferably, the thallium concentration in the second layer 22 is lower than or equal to 0.001 mass % of CsI with respect to Cs. The second layer 22 may contain substantially no thallium. The word “substantially” here means intentionally not adding thallium.

The thallium concentrations in the first and second layers 21 and 22 can be found, for example, by an emission analysis of the scintillator 20 in a depth direction (film thickness direction). A boundary between the first layer 21 and the second layer 22 is a place of change in a concentration profile of elemental thallium in the depth direction or a place of change in trend of the profile. In the case of uneven distributions of the thallium concentrations in the first and second layers 21 and 22, the average of values in the depth direction is determined as the thallium concentration in each layer.

In the scintillator 20, thallium forms a new energy level between a valence band that produces fluorescence based on CsI and a conduction band, thereby facilitating recombination of a hole-electron pair and enhancing the light emission efficiency of scintillation light. For detection of radiation with high sensitivity, it is preferable that the thallium concentration in the scintillator 20 be as high as a certain limit. However, it is found through discussion of the present disclosure that growing CsI polycrystals of a columnar structure causes thallium to accumulate at crystal grain boundaries, whereby thallium acts as a nucleus to cause crystals to also grow in a horizontal direction and be fused with adjacent crystals.

As will be described in detail below, the occurrence of such fusion of crystals enables radiation incident on each columnar crystal or scintillation light generated to travel through the inside of a thick CsI crystal in a direction perpendicular to a crystal growth direction, whereby the scintillation light becomes larger than it was at the position of incidence of the radiation and is detected by a photodiode 13. This causes decreases in contrast and resolution.

In the radiation detector 101 of the present embodiment, the thallium concentration in the second layer 22 of the scintillator 20 that is formed at a later stage of crystal growth is reduced so that such a decrease in resolution is avoided.

It is preferable that a thickness T2 of the second layer 22 be smaller than a thickness T1 of the first layer 21 (T2<T1), and for example, it is preferable that the thickness T2 be less than or equal to ½ of T1 (2·T2<T1). It is more preferable that the thickness T2 be less than or equal to ⅕ of T1 (5·T2<T1). For example, a total thickness (T1+T2) of the scintillator 20 is approximately 600 μm, and the thickness T2 of the second layer 22 is less than or equal to 100 μm.

In the scintillator 20, the CsI polycrystals of a columnar structure grow from the first surface 20a toward the second surface 20b. Typically, the second surface 20b is constituted by a plurality of conical surfaces 20c of the columnar crystals. Accordingly, the second surface 20b has asperities. On the other hand, the first surface 20a is substantially flat.

The metallic layer 31 is formed on top of the second surface 20b so as to bury the asperities. An adhesive layer may be placed in place of the metallic layer 31. The protective layer 32 is placed on top of the metallic layer 31.

The radiation detector 101 can be fabricated using a common semiconductor device manufacturing technology. The scintillator 20 can be formed using a publicly known vacuum deposition technology. For example, the active matrix substrate 10 is fabricated using a common semiconductor device manufacturing technology, and the upper surface 10b of the active matrix substrate 10 is planarized as appropriate using a planarizing technology such as CMP (chemical mechanical polishing).

Then, the scintillator 20 is formed using a publicly known vacuum deposition technology. For example, CsI and thallium are put into separate crucibles, and the active matrix substrate 10 is placed inside a film-forming chamber. The pressure in the film-forming chamber is reduced to a predetermined value, and by heating the crucibles, CsI and thallium are evaporated. The scintillator 20 thus formed on top of the active matrix substrate 10 is composed of a thallium-added CsI polycrystalline film. The timing of evaporation of CsI and thallium can be regulated by shutters placed at openings of the crucibles. Further, by controlling the temperatures of the crucibles, the rate of growth of the CsI polycrystalline film and the thallium concentration in the CsI polycrystalline film can be regulated.

As mentioned above, the scintillator 20 is located beside the active matrix substrate 10 and includes the first layer 21, which is formed first, and the second layer 22, which is located on top of the first layer 21 and formed after the first layer 21. The thallium concentration in the second layer 22 can be made lower than the thallium concentration in the first layer 21, for example, by, during the formation of the scintillator 20, varying the temperature of the crucible in which thallium is placed and, during the formation of the second layer 22, making the vapor pressure of thallium lower than it was during the formation of the first layer 21.

During the formation of the CsI polycrystalline film serving as the scintillator 20, polycrystals of CsI are formed on top of the active matrix substrate 10, and as the thickness of the film increases, the polycrystals grow in a film thickness direction. At this point in time, columnar crystals are formed while crystal grain boundaries 20d of the polycrystals are maintained. However, thallium atoms penetrate into the crystal grain boundaries 20d as the columnar crystals grow in the film thickness direction, the thallium acts as a nucleus to make it easy for the crystals to be fused, causing the columnar crystals to also grow in a horizontal direction.

In the present embodiment, such growth of crystals in a horizontal direction and fusion of the crystals are inhibited by making the thallium concentration in the second layer 22 of the scintillator 20 lower than the thallium concentration in the first layer 21. Accordingly, the crystal grain boundaries 20d of the columnar crystals are easily maintained. As a result of that, side faces of the columnar crystals are mostly connected to each other continuously between the first surface 20a and the second surface 20b. Although FIG. 1 illustrates each columnar crystal in such a manner that side faces of the columnar crystal are parallel to the film thickness direction, each columnar crystal may have such a shape of an inverted frustum that an upper surface beside the second surface 20b is larger than a bottom surface beside the first surface 20a.

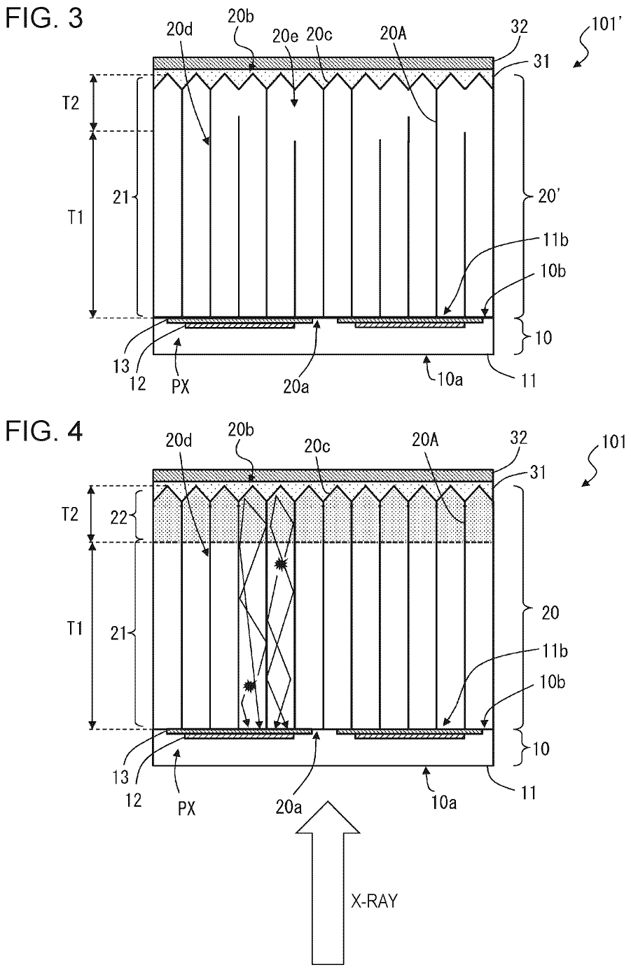

FIG. 3 is an enlarged cross-sectional view showing a configuration of principal components of a radiation detector 101′ including a scintillator 20′ having only a first layer 21 and having no second layer 22. Beside the second surface 20b, which is a crystal growth end of the scintillator 20′, parts of the side faces of adjacent columnar crystals are fused, with the result that the crystal grain boundaries 20d disappear and the crystals grow in a crosswise direction.

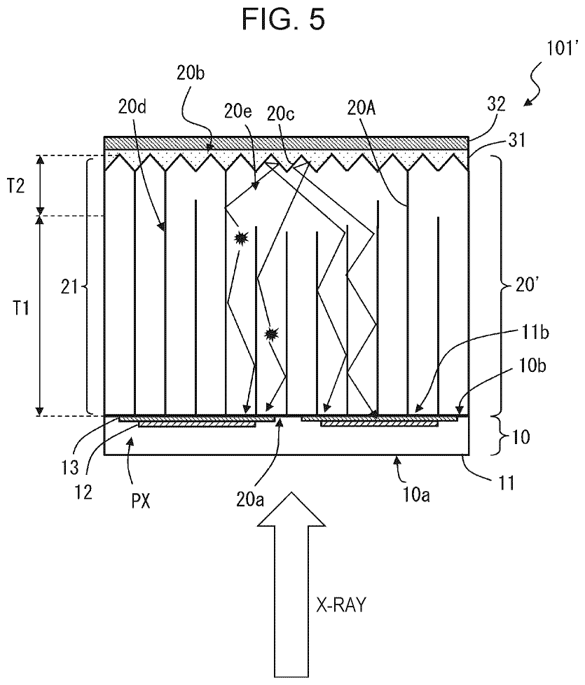

The following describes how the radiation detector 101 of the present embodiment operates. FIG. 4 is a schematic view explaining emission of light in the scintillator 20 based on X-rays incident on the radiation detector 101. FIG. 5 is a schematic view explaining emission of light in the scintillator 20 based on X-rays incident on the radiation detector 101′.

As shown in FIG. 4, in the radiation detector 101 of the present embodiment, a bottom surface 10a of the active matrix substrate 10 is irradiated with X-rays. After being transmitted through the active matrix substrate 10, the X-rays enter the scintillator 20 through the first surface 20a. In the scintillator 20, the side faces of each columnar crystal constitute crystal grain boundaries 20d with adjacent side faces, and air layers of a slight thickness are located at the crystal grain boundaries 20d. For this reason, scintillation light (visible light) produced within one columnar crystal by incoming X-rays propagate through the inside of the columnar crystal toward the first surface 20a and toward the second surface 20b while being repeatedly reflected off the side faces of the columnar crystal. Light arriving at the first surface 20a falls on a photodiode 13 from the first surface 20a. Further, light arriving at the second surface 20b is reflected at an interface with the metallic layer 31, enters the same columnar crystal, travels toward the first surface 20a while being reflected off the side faces, and falls on a photodiode 13.

Thus, in the radiation detector 101 of the present embodiment, side faces of the columnar crystals of the scintillator 20 are connected to each other continuously between the first surface 20a and the second surface 20b, whereby light generated by scintillation inside each columnar crystal does not propagate while spreading in the crosswise direction but falls on the photodiode closest to the columnar crystal. This inhibits the position of detection of light based on scintillation from becoming larger than the position of incidence of the X-rays, making it possible to acquire an image of high contrast and high resolution.

Further, the first surface 20a of the scintillator 20 is formed at an early stage of crystal growth and faces the photodiodes 13 of the active matrix substrate 10. That is, in a case where each columnar crystal of the scintillator 20 has the shape of an inverted frustum, a bottom surface constituting the first surface 20a is smaller than an upper surface constituting the second surface 20b in each columnar crystal. For this reason, light based on X-rays generated inside each columnar crystal is better inhibited from diffusing than in a case where the second surface 20b faces the photodiodes 13.

Further, X-rays incident on the scintillator 20 are gradually absorbed through the first surface 20a by emission of light by scintillation, a large portion of the incoming X-rays is absorbed at the first layer 21, so that there is a great decrease in the dose of X-rays that arrive at the second layer 22. For this reason, even when the second layer 22 is low in thallium concentration and lower in fluorescence quantum efficiency than the first layer 21, there is almost no decrease in fluorescence quantum efficiency of the scintillator 20 as a whole.

On the other hand, as shown in FIG. 5, the radiation detector 101′ has only the first layer 21 and has no second layer 22, whereby beside the second surface 20b, there is a fused portion 20e in which crystal grain boundaries 20d of columnar crystals disappear. When light based on scintillation enters the fused portion 20e, the light propagates through adjacent columnar crystals. This causes the light based on scintillation to become larger than it was at the position of incidence of the X-rays, resulting in decreases in contrast and resolution.

### Experimental Example

A result of fabricating a radiation detector 101 shown in FIG. 1 and measuring MTF characteristics is described. A radiation detector 101 having a scintillator 20 obtained by activating cesium iodide with thallium was fabricated. The thickness of the first layer 21 of the scintillator 20 was 500 μm, and the thickness of the second layer 22 was 100 μm. Further, the amount of thallium added to the first layer 21 was 1.5 mass %, and the amount of thallium added to the second layer 22 was 0 mass %. As a reference example for comparison, a radiation detector 101′ shown in FIG. 3 was fabricated. The radiating detector 101′ has a scintillator 20′. The scintillator 20 includes no second layer 22 and is constituted by only a first layer 21 having a thickness of 600 μm (which is equal to the sum of the thicknesses of the first and second layers 21 and 22 of the scintillator 20).

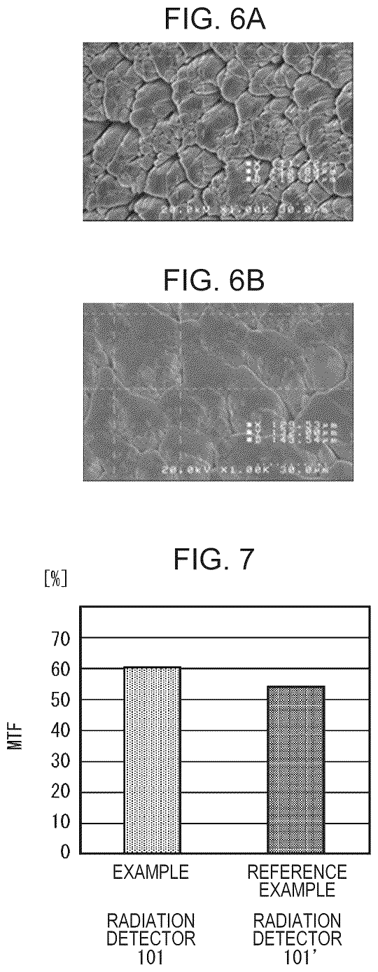

FIGS. 6A and 6B are diagrams showing surface structures obtained by observing, with an optical microscope, an area near an outer edge of the second surface 20b of the scintillator 20 and an area near an outer edge of the second surface 20b of the scintillator 20′. In the scintillator 20, crystal grains are kept relatively small. In the scintillator 20′, on the other hand, crystals grow large in the crosswise direction or adjacent crystals are fused with each other, with the result that crystal grain boundaries disappear.

The radiation detector 101 and the radiation detector 101′ were each irradiated with X-rays having a stripe pattern, and an image detected by the photodiodes 13 was acquired. Values of contrast in a stripe pattern of the image thus detected were calculated from the center to the outside of the image with the contrast of the stripe pattern of the incoming X-rays being 1 to produce MTF curves. FIG. 7 shows contrast ratios at positions near the outer edges of the second surfaces 20b shown in FIGS. 6A and 6B.

As shown in FIG. 7, the radiation detector 101 of the present embodiment gives a contrast of 60.6%. On the other hand, the radiation detector 101′ of the reference example gives a contrast of 53.6%. This shows that the radiation detector 101 of the present embodiment is higher in contrast by 10% or more than the radiation detector 101′ of the reference example.

Thus, according to the present embodiment, it is found that by the scintillator 20 having a second layer having a low thallium concentration, the fusion of columnar crystals at crystal grain boundaries is inhibited and light based on scintillator is inhibited from diffusing.

### Second Embodiment

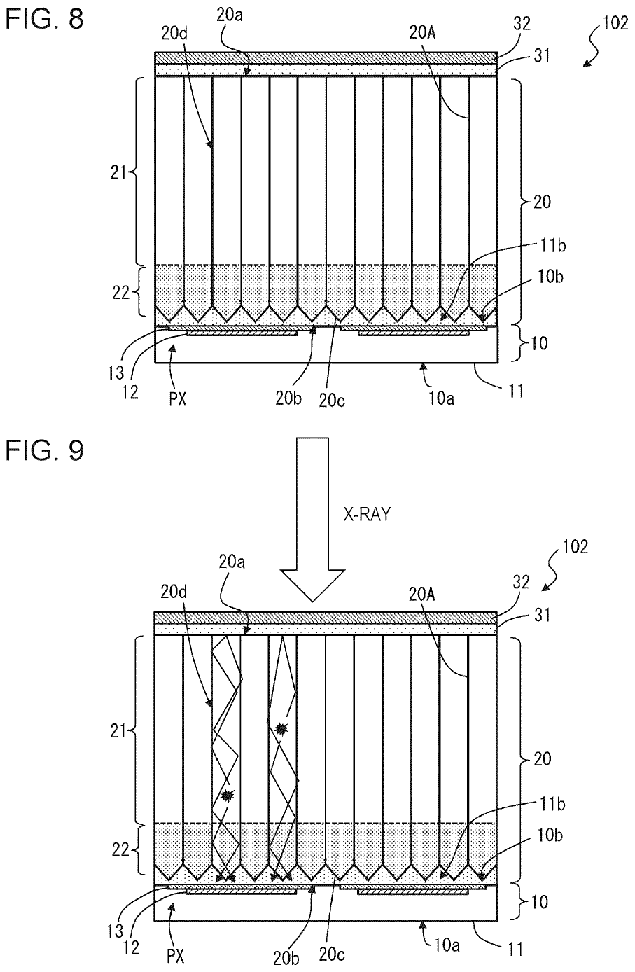

FIG. 8 is an enlarged cross-sectional view showing a configuration of principal components of a radiation detector 102 of the present embodiment. The radiation detector 102 differs from the radiation detector 101 of the first embodiment in that the scintillator 20 is placed upside down with respect to the active matrix substrate 10.

As shown in FIG. 8, in the radiation detector 102, the second surface 20b constituted by the conical surfaces 20c of the scintillator 20 faces the upper surface 10b of the active matrix substrate 10. An adhesive layer 33 is placed between the second surface 20b and the active matrix substrate 10. Meanwhile, the first surface 20a is located opposite the active matrix substrate 10 and is covered with a metallic layer 31. A protective layer 32 is located on top of the metallic layer 31. As in the case of the first embodiment, the scintillator 20 is constituted by polycrystalline columnar crystals of CsI activated by thallium. These columnar crystals grow from the first surface 20a toward the second surface 20b.

The radiation detector 102 can be fabricated, for example, in the following manner. First, the scintillator 20 is formed on top of another substrate. After that, the scintillator 20 is removed from the substrate, turned upside down, placed on top of the active matrix substate 10 via the adhesive layer 33 so that the second surface 20b faces the upper surface 10b of the active matrix substrate 10. In this way, the radiation detector 102 is obtained.

The following describes how the radiation detector 102 of the present embodiment operates. FIG. 9 is a schematic view explaining emission of light in the scintillator 20 based on X-rays incident on the radiation detector 102. As shown in FIG. 9, in the radiation detector 102 of the present embodiment, the protective layer 32, which is located beside the first surface 20a of the scintillator 20, is irradiated with X-rays. The X-rays are transmitted through the protective layer 32 and the metallic layer 31, and the scintillator 20 is irradiated with the X-rays through the first surface 20a. As in the case of the first embodiment, in the scintillator 20, scintillation light produced within one columnar crystal by incoming X-rays propagate through the inside of the columnar crystal toward the first surface 20a and toward the second surface 20b while being repeatedly reflected off the side faces of the columnar crystal. Light arriving at the second surface 20b is transmitted through the adhesive layer 33 from the second surface 20 and falls on a photodiode 13. Further, light arriving at the first surface 20a is reflected at an interface with the metallic layer 31, enters the same columnar crystal, travels toward the second surface 20b while being reflected off the side faces, and falls on a photodiode 13.

Thus, also in the radiation detector 102 of the present embodiment, side faces of the columnar crystals of the scintillator 20 are connected to each other continuously between the first surface 20a and the second surface 20b, whereby light generated by scintillation inside each columnar crystal does not propagate while spreading in the crosswise direction but falls on the photodiode closest to the columnar crystal. This inhibits the position of detection of light based on scintillation from becoming larger than the position of incidence of the X-rays, making it possible to acquire an image of high contrast and high resolution.

### Other Embodiments

A radiation detector of the present embodiment can be altered in various ways without being limited to the foregoing embodiments. For example, the film thicknesses and thallium concentrations of the first and second layers of the scintillator 20 are merely examples, and a radiation detector of the present embodiment may be constituted by other values. Further, the configuration of the active matrix substrate is also merely an example, and the active matrix substrate may include another structure.

A radiation detector of the present disclosure can also be described in the following manner.

A radiation detector according to a first configuration is a radiation detector including an active matrix substrate including a substrate and a plurality of pixels, placed on top of the substrate, that include their respective switching elements and their respective photoelectric conversion elements and a scintillator placed on top of the active matrix substrate so as to cover the photoelectric conversion elements of the plurality of pixels. The scintillator is constituted by columnar crystals of cesium iodide activated by thallium. The scintillator has first and second surfaces separated from each other in a thickness direction and first and second layers stacked on top of each other in the thickness direction between the first and second surfaces. The columnar crystals grow from the first surface toward the second surface. The second layer is located closer to the second surface than is the first layer. The second layer is lower in thallium concentration than the first layer.

According to the first configuration, the fusion of the columnar crystals at crystal grain boundaries and the growth of the crystals in a crosswise direction are inhibited by the second layer being low in thallium concentration. Therefore, side faces of the columnar crystals of the scintillator 20 are connected to each other continuously between the first surface 20a and the second surface 20b, and light emitted by scintillation inside each columnar crystal can be inhibited from propagating while spreading in the crosswise direction by being reflected off the side faces of the columnar crystals. This makes it possible to acquire an image of high contrast and high resolution.

A radiation detector according to a second configuration may be directed to the first configuration, wherein the second layer is smaller in thickness than the first layer.

A radiation detector according to a third configuration may be directed to the first configuration, wherein a concentration of elemental thallium in the second layer is lower than or equal to 1/10 of a concentration of elemental thallium in the first layer.

A radiation detector according to a fourth configuration may be directed to the first configuration, wherein the second surface is constituted by conical surfaces of the columnar crystals.

A radiation detector according to a fifth configuration may be directed to the first configuration, wherein the first surface faces an upper surface of the active matrix substrate and is irradiated with radiation from a bottom surface of the active matrix substrate.

A radiation detector according to a sixth configuration may be directed to the first configuration, wherein the second surface faces an upper surface of the active matrix substrate and is irradiated with radiation from the first surface of the scintillator.

The present disclosure contains subject matter related to that disclosed in Japanese Priority Patent Application JP 2025-033610 filed in the Japan Patent Office on Mar. 4, 2025, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A radiation detector comprising:
an active matrix substrate including a substrate and a plurality of pixels, placed on top of the substrate, that include their respective switching elements and their respective photoelectric conversion elements; and
a scintillator placed on top of the active matrix substrate so as to cover the photoelectric conversion elements of the plurality of pixels,
wherein
the scintillator is constituted by columnar crystals of cesium iodide activated by thallium,
the scintillator has first and second surfaces separated from each other in a thickness direction and first and second layers stacked on top of each other in the thickness direction between the first and second surfaces,
the columnar crystals grow from the first surface toward the second surface,
the second layer is located closer to the second surface than is the first layer, and
the second layer is lower in thallium concentration than the first layer.

2. The radiation detector according to claim 1, wherein the second layer is smaller in thickness than the first layer.

3. The radiation detector according to claim 1, wherein a concentration of elemental thallium in the second layer is lower than or equal to 1/10 of a concentration of elemental thallium in the first layer.

4. The radiation detector according to claim 1, wherein the second surface is constituted by conical surfaces of the columnar crystals.

5. The radiation detector according to claim 1, wherein the first surface faces an upper surface of the active matrix substrate and is irradiated with radiation from a bottom surface of the active matrix substrate.

6. The radiation detector according to claim 1, wherein the second surface faces an upper surface of the active matrix substrate and is irradiated with radiation from the first surface of the scintillator.
